(19) United States
(12) Patent Application Publication
(10) Pub. No.: US 2003/0008578 A1
(43) Pub. Date: Jan. 9, 2003

(54) Thermoretentive disposable wash cloth article and method

(76) Inventor: Jo Ann Brooks, Neenah, WI (US)

Correspondence Address: DOUGLAS G GLANTZ, ATTORNEY AT LAW, 5260 DEBORAH COURT, DOYLESTOWN, PA, 18901, US

(21) Appl. No.: 09/896,307

(22) Filed: Jun. 29, 2001

(51) Int. Cl. B32B 5/02; B32B 27/04; B32B 27/12; D04H 1/46; D04H 5/02

(52) U.S. Cl. 442/123; 442/394; 442/402

(57) ABSTRACT

A novel article and method are disclosed including a heated disposable wash cloth. In one aspect, the invention provides a novel article and method including a wash cloth structure having from about 75 to about 89 weight percent of a thermoretentive oil-in-water emulsion. In one aspect, the fiber content contains a 50/50 ratio of rayon and polyester compositionally part of the wash cloth substrate structure. The novel article and method of the present invention are effective in maintaining extended warmth on the skin and providing moisturization of the skin surface for up to 6 hours after washing.

### BACKGROUND OF THE INVENTION

1. Technical Field

This invention relates to a wash cloth formula applied to a cloth substrate and method. In one aspect, this invention relates to a novel wash cloth formula and method for preparing a thermoretentive disposable wash cloth.

2. Background

Disposable wash cloths and cleansing wipes currently find widespread use in many personal hygiene care applications. A disposable wash cloth or cleansing cloth includes a non-woven basesheet structure impregnated with a water solution or oil-in-water emulsion (lotion).

One niche in the disposable wash cloth product spectrum involves wash cloths which can be heated before applying to the skin. A number of micro-waveable bathkits have been available in the marketplace since 1993. Many of the commercial micro-waveable bathkit products are heated prior to use for 30 seconds to 1 minute in a microwave oven.

Conventional micro-waveable bathkit products have a chemical formula solution included as part of the product.

Martin et al. U.S. Pat. No. 5,702,992 discloses washcloths contained in a heat retentive container heated as a kit in a microwave prior to use.

Vera U.S. Pat. No. 5,135,518 discloses a medical compress having a heat retentive layer.

Strack et al. U.S. Pat. No. 4,913,957 discloses a fabric laminate for skin care having a heat retentive liquid.

Ponsi et al. U.S. Pat. No. 5,906,278 discloses a washcloth in cooperation with packaging to retain heat prior to use.

Peery U.S. Pat. No. 5,260,536 discloses a heat retaining napkin including several layers of materials including poly-olefin.

Anderson U.S. Pat. No. 5,150,707 discloses a thermal pack resin in particulate form adhered to a substrate.

Salee U.S. Pat. Nos. 5,630,961 and 5,424,519 disclose a microwave-activated thermal storage material used for foot and hand warmers and various microwave responsive materials including waxes and additional materials responsive to microwave energy.

Reid, Jr. et al. U.S. Pat. No. 5,572,744 discloses a mitten having pouches for receiving heat transfer material.

### INTRODUCTION TO THE INVENTION

Although currently available micro-waveable bathkit products have been in distribution and use in acute care and long term care settings and recently in the mass market, these current products could benefit from improvement in specific areas. For example, the chemical formula solutions of conventional micro-waveable bathkit products included in and as part of a wash cloth in the bathkit are found to heat unevenly and rapidly, and also cool rapidly resulting in a cold feeling wash cloth very quickly.

A new approach to bedside bathing is needed to improve the level of comfort for care receivers. An improved wash cloth or bathkit is needed, which when heated in a microwave or other heating device, would provide an ability to extend the length of time the wash cloth or cleansing wipe remains warm.

Accordingly, there is a need for a novel wash cloth or cleansing wipe which can provide extended warmed use.

It is an object of the present invention to provide a novel wash cloth or cleansing wipe article, formula and cloth basesheet capable of washing or cleansing the body of bedbound consumers.

It is an object of the present invention to provide a novel wash cloth or cleansing wipe article, thermoretentive formula, and basesheet which is disposable.

It is a further object of the present invention to provide a novel wash cloth or cleansing wipe article and method which are disposable and which are capable of being warmed up for use.

It is another object of the present invention to provide a novel disposable wash cloth or cleansing wipe article and method which does not cool rapidly resulting in a cold feeling wash cloth very quickly.

It is another object of the present invention to provide a novel disposable wash cloth or cleansing wipe article which heats evenly and rapidly but which does not cool rapidly resulting in a cold feeling wash cloth very quickly.

It is an object of the present invention to provide a novel disposable wash cloth or cleansing wipe article and method using a material safe for application to the fragile skin of elders.

It is an object of the present invention to provide a novel disposable wash cloth or cleansing wipe article and method which, when heated in a microwave or other heating device, provide an ability to extend the length of time the wash cloth or cleansing wipe remains warm.

These and other objects of the present invention will become apparent from a careful inspection of the detailed description which follows.

### SUMMARY OF THE INVENTION

The present invention provides an article and method including a heated disposable wash cloth.

In one aspect, the invention provides a novel article including a wash cloth structure having from about 50% Rayon and 50% Polyester. The basis weight is 4.0 oz. per yard².

In one aspect, the wash cloth fabric is compositionally part of the wash cloth structure, but also contains a formulated composition of skin humectants, lipids, silicone waxes, and neutral triglycerides.

The novel article of the present invention is also effective in the hydration, moisturization, and relipidization of fragile mature skin. The moisturization levels are retained in the skin for up to 6 hours after washing.

The novel article of the present invention retains warmth for three (3) times longer than conventional cleansing solutions which contain a predominance of water.

### DETAILED DESCRIPTION

The present invention includes an article and formula for providing novel wash cloths, which are disposable, and which are capable of being warmed up for use.

The article and method of the present invention provide a disposable wash cloth with heat retentive properties. The heat retentive properties originate from additions of heat retentive oils, waxes, silicones and polymers. The heat retentive wash cloth is a “comfort” benefit for those unable to take a warm shower or bath.

Low melting point natural triglyceride waxes are added to the oil-in-water emulsion comprising the chemical formula to be applied to the skin. A preferred wax is Softisan 378 (2-8%). Alternative waxes are hydrogenated vegetable oil, hydrogenated coco-glycerides, carnuba wax, hydrogenated palm glycerides, shea butter, and candelilla wax.

An oil-in-water emulsion contains a mixture of low to medium melting point silicone waxes, humectants, and specific oil soluble thermoretentive polymers. The oil phase of the emulsion contains emulsifiers, emulsion stabilizers, oil soluble polymers such as Acrylates/C10-30 Alkyl Acrylate Crosspolymer, Tricontanyl PVP, such that a stable emulsion is formed for applying to substrate basesheets under pressure. Alternative oil soluble polymers are PVP Hexadecene Copolymer, PVP/Eicosene Copolymer which are preferred for their substantivity to keratin materials (skin). An oil dispersible polymer such as Acrylates/C-10-30 Alkyl Acrylate Cross Polymer is preferred for ion tolerance. Alternative water soluble polymers such as carbomers, hydroxyethylcellulose, xanthan gum, or hydroxypropyl methylcellulose are suitable as well, but do not provide high heat retentiveness.

An insulating polyacryamide gel liner surrounds the wash cloths to keep the cloths warm until the care giver is ready to use them. Alternative water soluble gels are cetyl hydroxy-ethylcellulose, gelled PVP with added inorganic salts such as sodium chloride, zinc chloride, magnesium sulfate, and glyceryl polymethacrylates with glycols. Gelled oils such as mineral oil, such as Penreco Versagel, are also suitable for packaging insulating material inserts.

The material description for all the types of basesheet (substrate) materials includes a substrate which preferably is water insoluble and low Tinting so as not to catch on calloused skin or open wound beds. The preferred substrate does not come apart in water or on exposure to surfactants in the formula. The preferred substrate has adequate wet tensile strength for durability during washing of the body. The preferred substrate is very gentle (non-abrasive) on the fragile skin of elders. The preferred substrate characteristics include adequate loft, porosity with excellent fluid retention properties so that impregnated solutions or emulsions remain on the basesheet, and do not pool or puddle at the bottom of the container. The preferred substrate has a thickness for a plush feel on the skin and a size for a bathing wash cloth, e.g., such as in the range of about 8-12 inch squares.

The material for basesheets include nonwovens made by hydro-entangling, needlepunching, meltblowing, coforming, thermo-bonding, spunbonding, air-laying, water-laying, or carding pro-cesses. Materials can include dacron, nylon, fortrel, rayon, polyester and kodel. Combinations of synthetic and natural cellulosic materials have also been used. The most preferred synthetic fibers are rayon and polyesters and mixtures of rayon and polyesters. The most preferred natural materials are wood pulp and cotton fibers and mixtures of wood pulp and cotton fibers.

The basis weight should be 4.0 oz. per yard².

The chemical names for the heat retentive formula of the present invention are provided in Table 1 by trade name and the INCI/CTFA name used in industry.

TABLE 1

| Trade Name | INCI/CTFA name used in industry |
|---|---|
| Water | Deionized Water |
| Dow Propylene Glycol | Propylene Glycol |
| Dow Chemicals Optime Glycerin | Glycerin |
| Adjinomoto Ajidew NL-50 | Sodium PCA |
| Roche Dex panthenol | Panthenol |
| Dow Chemicals Versene Na | Disodium EDTA |
| Bell Fragrances Aloe Vera Powder | Aloe Barbadensis |
| Condea Vista Softisan 378 | Caprylic/Capric/Stearic Tri- |
| | glyceride |
| Lipo Chemicals Liponate GC | Caprylic/Capric Triglyceride |
| Dow Corning 580 Wax | Stearoxytrimethylsilane (and) |
| | stearyl alcohol |
| Dow Corning 225 Fluid | Dimethicone |
| Aldol-NF Flaked | Cetyl alcohol |
| Uniquema Brij 721S | Steareth-21 |
| Roche Tocopheryl Acetate | Tocopheryl Acetate |
| Uniquema Brij 72 | Steareth-2 |
| Lipo Chemicals Lipopeg 39S | PEG-40 Stearate |
| Nipa Hardwicke Propylparaben | Propylparaben |
| BF Goodrich Pemulin TR-2 | Acrylates/ |
| | C10-30 Alkyl Acrylate |
| | Crosspolymer |
| Henkle Cognis Cetiol SB-45 | Shea Butter |
| Nipa Hardwicke Phenoxyethanol | Phenoxyethanol |
| ISP/Sutton Germall II | Diazolidinyl Urea |
| Givaudan Roure Fragrance | Fragrance |
| Nipa Hardwicke Methylparaben | Methylparaben |
| Dow triethanol amine | triethanol amine |

Other alternate chemicals for Permulin TR2 are Ganex V-216, Tricontanyl PVP and PVP/Eicosene Copolymer.

Other chemicals for stated silicones (Dow Corning 580 silicone wax and Dow Corning Dimethicone 225) are Cetyl Dimethicone, Phenyl Trimethicone, Cyclomethicone, Dimethicone 200 fluid and Trimethylsiloxysilicate, and Simethicone.

Other chemicals (fats and oils) for relipidizing the skin-(Shea butter and both triglycerides) are hydrogenated vegetable oil, shark liver oil, alpha lipoic acid, sunflower seed oil, super refined avacado oil, sesame oil, almond oil, hydrogenated coco-glycerides, lanolin, lanolin oil, lanolin alcohol, bis-diglyceryl polyacyladipate-1, mango butter, glyceryl ricin-oleate, carrot oil, and hydrogenated palm oil.

Other humectants or alternatives to glycerin, sodium poly-aspartate, and propylene glycol are glycosaminoglycans, muco-polysaccahrides, sodium PCA, sorbitol, mannitol, dextrin, soluble collagen, maltodextrin, xylitol, sodium lactate, maltitol, honey, glycereth -26, aceamide MEA, lactamide MEA, PEG-12, and ethoxy-diglycol.

Preservatives other than Germall II, methylparaben, propyl-paraben, and phenoxyethanol are DMDM Hydantoin, iodopropynyl butylcarbamate, 2-bromo-2 nitropane-1,3-diol, and imidazolidinyl urea.

Urease inhibition chemistries such as disodium EDTA are added to control skin odors arising from bacterial ureases.

Heat retentive chemicals include the emulsifiers of steareth-2, steareth-21, or PEG-40 stearate; emollients of Shea butter and the triglycerides; silicone oil; and waxes of Dow Corning 580 wax; zinc sulfate; and PVP/hexadecene copolymer.

Additional heat retentive multirange melting point organic waxes include candelilla wax, carnauba wax, beeswax, lecithin, behenyl beeswax, ceresin, microcrystalline wax, myreth-3 myristate, myristyl myristate, oleyl ecrucate, cetyl alcohol, cetearyl alcohol, cetyl esters, lanolin, and cetyl palmitate.

### EXAMPLE

A oil-in-water emulsion composed of mid to high melting point waxes, and oil soluble polymers was added to a 4.0 oz. per yard² needlepunch basesheet (50% rayon and 50% polyester)

It has been found empirically that the thermoretentive properties were extended by three times beyond what was observed with a conventional water solution on the wash cloth substrate. The wash cloth remained warm for 32 seconds on average.

The article and method of the present invention are capable of modifications and variations without departing from the scope of the present invention. Accordingly, the detailed description and examples set forth above are meant to be illustrative only and are not intended to limit the scope of the invention as set forth in the appended claims.

What is claimed is:

1. A thermal retentive wash cloth, comprising a disposable cloth containing needle-punched rayon and polyester, a thermoretentive polymer, and a formulation of thermoretentive mixtures of low to mid-melting point organic waxes.

2. The thermal retentive wash cloth as set forth in claim 1, wherein a thermoretentive silicone wax comprises a low melting point organic wax with melting point of 48 degrees Celsius.

3. The thermal retentive wash cloth as set forth in claim 2, wherein said thermoretentive polymer comprises an oil soluble Acrylates/C10-30 Alkyl Acrylate Crosspolymer.

4. The thermal retentive wash cloth as set forth in claim 2, wherein said needle-punched basesheet material comprises rayon and polyester.

5. The thermal retentive wash cloth as set forth in claim 4, wherein said disposable cloth containing rayon and polyester is impregnated with a thermoretentive silicone wax comprising Dow Corning 580 silicone wax.

6. The thermal retentive wash cloth as set forth in claim 2, wherein thermoretentive lipids comprise caprylic triglyceride, capric triglyceride, or stearic triglyceride, or combinations of caprylic triglyceride, capric triglyceride, or stearic tri-glyceride.

7. The thermal retentive wash cloth as set forth in claim 2, wherein low melting point triglyceride wax comprises a triglyceride wax having a melting point above about 37° C.

8. The thermoretentive wash cloth as set forth in claim 2, where in said cloth contains humectants to hydrate and moisturize fragile skin wherein said humectants comprise a mixture of Sodium PCA, Glycerin, and Propylene Glycol.

9. The thermal retentive wash cloth as set forth in claim 2, comprising a disposable cloth containing a needle-punched basesheet, heat retentive formulation chemical, and heat retentive insulating packaging components consisting of a high density polyethylene thin film containing metal salts such as sodium chloride, potassium chloride, and zinc sulfate.

10. The thermal retentive wash cloth as set forth in claim 9, comprising a disposable cloth containing a needle-punch basesheet having 50% rayon and 50% polyester.

11. The thermal retentive wash cloth as set forth in claim 6, wherein thermoretentive triglyceride oils and waxes comprise 2-8% by weight of caprylic triglyceride, capric triglyceride, or stearic triglyceride, or combinations of caprylic triglyceride, capric triglyceride, or stearic triglyceride.

12. The thermal retentive wash cloth as set forth in claim 6, wherein said thermoretentive wax further comprises ceresin mid-melting point wax.

13. The thermal retentive wash cloth as set forth in claim 2, wherein said thermoconducting polymer comprises hydrogenated vegetable oil, hydrogenated coco-glycerides, carnuba wax, hydro-genated palm glycerides, Shea butter, and candelilla wax.

14. The thermal retentive wash cloth as set forth in claim 2, comprising an oil-in-water emulsion in a mixture of mid to high melting point waxes.

15. The thermal retentive wash cloth as set forth in claim 14, wherein the oil phase of the emulsion contains emulsifiers, emulsion stabilizers, fatty alcohols, and oil soluble polymers.

16. The thermal retentive wash cloth as set forth in claim 14, comprising PVP Hexadecene Copolymer, PVP/Eicosene Copolymer to form substantivity to keratin materials (skin).

17. The thermal retentive wash cloth as set forth in claim 14, comprising a oil dispersible polymer of Acrylates/C-10-30 Alkyl Acrylate cross polymer to form ion tolerance.

18. The thermal retentive wash cloth as set forth in claim 14, comprising water soluble polymers carbomers, hydroxy-ethylcellulose, xanthan gum, or hydroxypropyl methylcellulose.

19. The thermal retentive wash cloth as set forth in claim 2, further comprising an insulating polyacryamide gel liner surrounding the wash cloth to maintain the cloths in a warm condition until the care giver is ready to use them.

20. The thermal retentive wash cloth as set forth in claim 2, comprising a water soluble gel of cetyl hydroxyethylcellulose, gelled PVP with added inorganic salts or glyceryl poly-methacrylates with glycols in low to high density polyethylene or polypropylene.

21. The thermal retentive wash cloth as set forth in claim 2, comprising a gelled oil of Penreco Versagel mineral oil for packaging insulating material inserts.

22. The thermal retentive wash cloth as set forth in claim 2, comprising a water insoluble basesheet substrate having low linting and a basis weight of 4.0 oz. per yard².

23. A method for warming a wash cloth, comprising providing a disposable cloth containing needle-punched rayon and polyester, providing a thermoretentive polymer in said cloth, and formulating thermoretentive mixtures of low to mid-melting point organic waxes in connection with said thermoretentive polymer.

24. A thermal retentive wash cloth, comprising a disposable cloth containing needle-punched rayon and polyester, a thermoretentive polymer, and a formulation of thermoretentive mixtures of organic waxes, wherein said disposable cloth includes a thermoretentive silicone wax wash cloth structure having from about 75 to about 89 weight percent of a thermoretentive oil-in-water emulsion and a fiber content containing a 50/50 ratio of rayon and polyester compositionally part of a wash cloth substrate structure.
